(19) United States
(12) Patent Application Publication
(10) Pub. No.: US 2006/0287418 A1
(43) Pub. Date: Dec. 21, 2006

(54) Nanoparticulate phosphorus-containing flame retardant system

(75) Inventors: Harald Bauer, Kerpen (DE); Werner Krause, Huerth (DE); Martin Sicken, Koeln (DE); Norbert Weferling, Huerth (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/182,459

(22) Filed: Jul. 15, 2005

(30) Foreign Application Priority Data
Jul. 22, 2004 (DE) 10 2004 035 517.7

(51) Int. Cl. C08K 5/52

(52) U.S. Cl. 524/127

(57) ABSTRACT

The invention relates to a nanoparticulate phosphorus-containing flame retardant system, which comprises a phosphinic salt of the formula (I) and/or a diphosphinic salt of the formula (II) and/or their polymers, 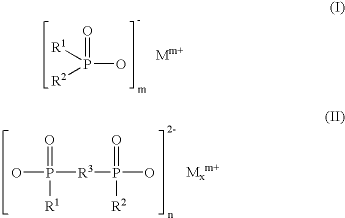 where
R¹ and R² are identical or different and are C₁-C₆-alkyl, linear or branched, and/or aryl;
R³ is C₁-C₁₀-alkylene, linear or branched, C₆-C₁₀-arylene, -alkylarylene, or -arylalkylene; M is Mg, Ca, Al, Sb, Sn, Ge, Ti, Fe, Zr, Zn, Ce, Bi, Sr, Mn, Li, Na, K, and/or a protonated nitrogen base; m is from 1 to 4; n is from 1 to 4; x is from 1 to 4; and to a process for the preparation of these flame retardant systems, and to their use.

The present invention is described in the German priority application No. 10 2004 035 517.7, filed 22 Jul. 2004, which is hereby incorporated by reference as is fully disclosed herein.

The invention relates to a nanoparticulate phosphorus-containing flame retardant, to a process for the preparation of these products, and to their use.

Nanocomposites of plastics and of nanoparticulate fillers (nanofillers) exhibit exceptional improvements in properties due to their particular structure, examples being an increase in stiffness and an improvement in the impact resistance of plastics moldings.

Known nanofillers are organically modified phyllosilicates (bentonites, montmorillonites, hectorites, saponites, etc.).

A disadvantage is that they cannot themselves achieve adequate flame retardancy, because they merely act as inert substance.

Attempts have therefore been described in the literature to combine nanofillers with other flame retardants with the aim of improved mechanical elasticity values and flame retardancy.

The aim here is to stabilize the flame-retardant polymer melt with nanofiller and to raise the glow-wire ignition temperature (GWIT). A disadvantage is that the nanofiller acts as inert substance and has to be used in addition to the flame retardant. The result is an increase in the solids content of the flame-retardant polymer molding, in turn impairing the mechanical elasticity values.

Surprisingly, it has now been found that the glow-wire ignition temperature can be increased solely via use of a nanoparticulate flame retardant system. The organically intercalated phyllosilicate can therefore be omitted. The solids content in the flame-retardant polymer molding composition can thus be lowered. This permits production of flame-retardant polymer moldings with markedly improved mechanical elasticity values.

Surprisingly, it has also been found that the inventive nanoparticulate phosphorus-containing flame retardant system increases light transmission in transparent plastics when comparison is made with non-nanoparticulate phosphorus-containing flame retardant systems.

The invention therefore provides a nanoparticulate phosphorus-containing flame retardant system, which comprises a phosphinic salt of the formula (I) and/or a diphosphinic salt of the formula (II) and/or their polymers,

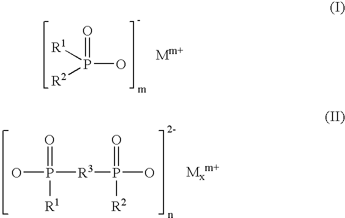

where

R¹ and R² are identical or different and are C₁-C₆-alkyl, linear or branched, and/or aryl;

R³ is C₁-C₁₀-alkylene, linear or branched, C₆-C₁₀-arylene, -alkylarylene, or -arylalkylene;

M is Mg, Ca, Al, Sb, Sn, Ge, Ti, Fe, Zr, Zn, Ce, Bi, Sr, Mn, Li, Na, K, and/or a protonated nitrogen base;

m is from 1 to 4;

n is from 1 to 4;

x is from 1 to 4.

M is preferably aluminum, calcium, titanium, zinc, tin, or zirconium.

Among protonated nitrogen bases, preference is given to the protonated bases of ammonia, melamine, or triethanolamine, in particular NH₄⁺.

R¹ and R², identical or different, are preferably C₁-C₆-alkyl, linear or branched, and/or phenyl.

R¹ and R², identical or different, are particularly preferably methyl, ethyl, n-propyl, isopropyl, n-butyl, tert-butyl, n-pentyl and/or phenyl.

R³ is preferably methylene, ethylene, n-propylene, isopropylene, n-butylene, tert-butylene, n-pentylene, n-octylene, or n-dodecylene.

Other preferred meanings of R³ are phenylene or naphthylene.

Other preferred meanings of R³ are methylphenylene, ethylphenylene, tert-butylphenylene, methylnaphthylene, ethylnaphthylene, or tert-butyinaphthylene.

Other preferred meanings of R³ are phenylmethylene, phenylethylene, phenylpropylene, or phenylbutylene.

Preferred phosphinic salts are aluminum trisdiethylphosphinate, aluminum trismethylethylphosphinate, aluminum tridiphenylphosphinate, and mixtures thereof.

Preferred aluminum trisdiethylphosphinates comprise from 0.01 to 10% of ancillary constituents from the group of aluminum ethylbutylphosphinate, aluminum ethylphosphonate, aluminum phosphite, and/or aluminum hypophosphite.

Other preferred phosphinic salts are zinc bisdiethylphosphinate, zinc bismethylethylphosphinate, zinc bisdiphenylphosphinate, and mixtures thereof.

Preferred zinc bisdiethylphosphinates comprise from 0.01 to 10% of ancillary constituents from the group of zinc ethylbutylphosphinate, zinc ethylphosphonate, zinc phosphite, and/or zinc hypophosphite.

Other preferred phosphinic salts are titanyl bisdiethylphosphinate, titanium tetrakisdiethylphosphinate, titanyl bismethylethylphosphinate, titanium tetrakismethylethylphosphinate, titanyl bisdiphenylphosphinate, titanium tetrakisdiphenylphosphinate, and any desired mixtures thereof.

The median particle size (d₅₀) of the inventive nanoparticulate phosphorus-containing flame retardant system is from 1 to 1000 nm, particularly preferably from 10 to 500 nm.

The BET surface area of the inventive nanoparticulate phosphorus-containing flame retardant system is from 2 to 1000 m²/g, particularly preferably from 5 to 500 m²/g.

The preferred bulk density of the inventive nanoparticulate phosphorus-containing flame retardant system is from 10 to 1000 g/l, particularly preferably from 40 to 400 g/l.

The preferred residual moisture level of the inventive nanoparticulate phosphorus-containing flame retardant system is from 0.01 to 10% by weight, particularly preferably from 0.1 to 1%.

Preferred L color values of the inventive nanoparticulate phosphorus-containing flame retardant systems are from 85 to 99.9, particularly from 90 to 98. Nanoparticulate phosphorus-containing flame retardant systems with L values below the inventive range require more use of white pigment. This impairs the mechanical stability properties of the polymer molding (e.g. modulus of elasticity).

Preferred a color values of the inventive nanoparticulate phosphorus-containing flame retardant systems are from −4 to +9, particularly from −2 to +6.

Preferred b color values of the inventive nanoparticulate phosphorus-containing flame retardant systems are from −2 to +6, particularly from −1 to +3.

The color values stated are from the Hunter system (CIE-LAB-System, Commission Internationale d'Eclairage). L values range from 0 (black) to 100 (white), a values from −a (green) to +a (red), and b values from −b (blue) to +b (yellow).

Nanoparticulate phosphorus-containing flame retardant systems with a or b values outside the inventive range require more use of white pigments. This impairs the mechanical stability properties of the polymer molding (e.g. modulus of elasticity).

The inventive nanoparticulate phosphorus-containing flame retardant system also particularly preferably takes the form of bodies whose length:diameter ratio is from 1:1 to 1 000 000:1. These are often also termed nanofibers.

The nanoparticulate phosphorus-containing flame retardant system preferably takes the form of a dispersion in polymers.

The nanoparticulate phosphorus-containing flame retardant system preferably has the final particle size prior to dispersion in polymers. This size is achieved via suitable production processes.

The invention also provides a process for the preparation of the inventive nanoparticulate phosphorus-containing flame retardant system, which comprises reacting
A) an aluminum/zinc/titanium/zirconium compound and/or tin compound with

1B) a soluble compound of phosphinic acid of the formula (I) and/or diphosphinic acid of the formula (II) and/or their polymers, and, if appropriate,
C) from 0.01 to 10% by weight of protective colloids and/or crystallization modifiers,

and optionally isolating the product from the solvent and/or from ancillary components, drying it, and grinding it.

The invention also provides another process for the preparation of the inventive nanoparticulate phosphorus-containing flame retardant system, which comprises
A) hydrolyzing an aluminum/titanium/zinc/tin compound and/or zirconium compound, and then
B) reacting the product with a soluble compound of phosphinic acid of the formula (I) and/or diphosphinic acid of the formula (II) and/or their polymers, or carrying out the hydrolysis itself in their presence, and optionally isolating the product from the solvent, isolating it from ancillary components, drying it, and grinding it.

The reaction in these processes is preferably conducted in a microreactor and/or minireactor.

In this process it is preferable that the metal charge equivalent/mol of phosphorus ratio A:B in which components A) and B) are used is from 100:1 to 1:100, preferably from 10:1 to 1:10.

In this process it is preferable that the temperature is from 0 to 300° C., the reaction time is from 1*10⁻⁷ to 1*10² h, and the pressure is from 1 to 200 MPa.

In this process, the preferred throughput (volume flow) in a microreactor is from 10⁻³ l/h to 10³ l/h, and in a minireactor is from 10² l/h to 10⁵ l/h.

The invention also provides another process for the preparation of an inventive nanoparticulate phosphorus-containing flame retardant system, which comprises wet-grinding of a non-nanoparticulate phosphorus-containing flame retardant system and thus bringing its particle size to from 1 to 1000 nm, preferably from 5 to 500 nm, if appropriate with addition of from 0.01 to 10% by weight of protective colloids and/or crystallization modifiers, and optionally isolating the product from the solvent, isolating it from ancillary components, drying it, and grinding it.

In this process it is preferable that the non-nanoparticulate phosphorus-containing flame retardant system is dispersed at a concentration of from 0.1 to 50% by weight, preferably from 1 to 20% by weight, in a solvent, the temperature being from 0 to 300° C., the reaction time being from 1*10⁻⁷ to 1*10² h, and the pressure being from 1 to 200 MPa.

In this process it is preferable that the isolation of the nanoparticulate phosphorus-containing flame retardant system from the solvent takes place via filtration, sedimentation, or centrifuging.

In this process it is preferable that the isolation of the nanoparticulate phosphorus-containing flame retardant system from ancillary components takes place via treatment with solvent in a ratio of from 1:100 to 100:1 parts by weight, and isolation of the nanoparticulate phosphorus-containing flame retardant system from the solvent via filtration, sedimentation, or centrifuging.

In this process it is preferable that the drying takes place in one or more stages at a pressure of from 10 Pa to 100 MPa, for a period of from 0.01 to 1000 h, and at a temperature of from −20 to +500° C., preferably at from 50 to 350° C.

In this process it is preferable that grinding takes place by means of hammer mills, impact mills, vibratory mills, roll mills, and floating-roller mills, and/or air-jet mills.

In this process it is preferable that the concentration of component B in the inventive solvent is from 0.1 to 50% by weight, particularly from 1 to 30% by weight, of phosphorus.

In this process it is preferable that the aluminum/titanium/zinc/tin compounds and/or zirconium compounds are organic compounds.

The invention also provides the use of an inventive nanoparticulate phosphorus-containing flame retardant system in polymer molding compositions, in polymer moldings, in polymer filaments, in polymer films, and/or in polymer fibers.

The invention also provides the use of an inventive nanoparticulate phosphorus-containing flame retardant system in flame-retardant coatings, formulations for the preparation of flame-retardant coatings (gel coats, intumescence lacquers, clear lacquers, topcoats, adhesives, adhesion coatings) and of impregnating compositions for porous moldings, such as wood, particle board, cork, paper, and textiles.

Component A is preferably the compounds of aluminum, of zinc, of titanium, of zirconium, and/or of tin having inorganic anions of the seventh main group (halides), e.g. fluorides, chlorides, bromides, iodides; having anions of the oxo acids of the seventh main group (hypohalites, halites, halates, for example iodate, perhalates, for example perchlorate); having anions of the sixth main group (chalcogenides), e.g. oxides, hydroxides, peroxides, superoxides; having anions of the oxo acids of the sixth main group (sulfates, hydrogensulfates, sulfate hydrates, sulfites, peroxosulfates); having anions of the fifth main group (pnicogenides), e.g. nitrides, phosphides; having anions of the oxo acids of the fifth main group (nitrate, nitrate hydrates, nitrites, phosphates, peroxophosphates, phosphites, hypophosphites, pyrophosphates); having anions of the oxo acids of the fourth main group (carbonates, hydrogencarbonates, hydroxide carbonates, carbonate hydrates, silicates, hexafluorosilicates, hexafluorosilicate hydrates, stannates); having anions of the oxo acids of the third main group (borates, polyborates, peroxoborates); having anions of the pseudohalides (thiocyanates, cyanates, cyanides); having anions of the oxo acids of the transition metals (chromates, chromites, molybdates, permanganate).

Component A is particularly preferably the compounds of aluminum, of zinc, of titanium, of zirconium, and/or of tin having organic anions from the group of the mono-, di-, oligo-, or polycarboxylic acids (salts of formic acid (formates), of acetic acid (acetates, acetate hydrates), of trifluoroacetic acid (trifluoroacetate hydrates), propionates, butyrates, valerates, caprylates, oleates, stearates, of oxalic acid (oxalates), of tartaric acid (tartrates), citric acid (citrates, basic citrates, citrate hydrates), benzoic acid (benzoates), salicylates, lactic acid (lactate, lactate hydrates), acrylic acid, maleic acid, succinic acid, of amino acids (glycine), of acidic hydroxy functions (phenolates etc.), para-phenolsulfonates, para-phenolsulfonate hydrates, acetylacetonate hydrates, tannates, dimethyldithiocarbamates, trifluoromethanesulfonate, alkylsulfonates, aralkylsulfonates.

Other preferred components A are the compounds of aluminum, of zinc, of titanium, of zirconium, and/or of tin having anions from the group of the monoorganylphosphinates such as mono(C₁-₁₈-alkyl)phosphinates, mono(C₆-C₁₀-aryl)phosphinates, mono(C₁-₁₈-aralkyl)phosphinates, e.g. monomethylphosphinates, monoethylphosphinates, monopbutylphosphinates, monobhexylphosphinates, monophenylphosphinates, monobenzylphosphinates, etc.

Other preferred components A are the compounds of aluminum, of zinc, of titanium, of zirconium, and/or of tin having anions from the group of the monoorganylphosphonates such as mono(C₁-₁₈-alkyl)phosphonates, mono(C₆-C₁₀-aryl)phosphonates, mono(C₁-₁₈-aralkyl)phosphonates, e.g. monomethylphosphonates, monoethylphosphonates, monobutylphosphonates, monohexylphosphonates, monophenylphosphonates, monobenzylphosphonates, etc.

Component B is preferably a soluble compound of phosphinic acid of the formula (I) and/or diphosphinic acid of the formula (II), and/or their polymers.

Soluble means that component B dissolves in the inventive solvent to give a solution whose concentration of B is from 0.1 to 50% by weight of phosphorus.

It is preferable that from 0.01 to 10% by weight of protective colloids and/or crystallization modifiers, based on nanoparticulate phosphorus-containing flame retardant system, are used during the reaction of components A and B.

Examples of preferred protective colloids and/or crystallization modifiers are polymeric quaternary ammonium salts (®Genamin PDAC, Clariant), polyethyleneimine (®Lupasol G 20, BASF), gallic acid, gelatin, polyethylene sorbitol monooleate (®Polysorbate 80), sodium carboxymethylcellulose, polyvinylpyrrolidone, phosphonic acids and their salts (ethylphosphonic acid, [(phosphonomethyl)imino]bis[2,1-ethanediylnitrilobis(methylene)]tetrakisphosphonic acid (®Cublen D50), aminotris(methylene)phosphonic acid (®Cublen AP 5), 1-hydroxyethane-1,1-diphosphonic acid (®Cublen K 60) and/or sodium pyrophosphate.

The inventive nanoparticulate phosphorus-containing flame retardant system preferably comprises from 0.01 to 10% by weight of protective colloids and/or crystallization modifiers.

Sol-gel process for the preparation of a nanoparticulate phosphorus-containing flame retardant system:

One inventively preferred process for the preparation of a nanoparticulate phosphorus-containing flame retardant system is preparation by the sol-gel process, where a component A is hydrolyzed and then is reacted with a component B. In another embodiment, component A is hydrolyzed in the presence of component B.

Preferred components A are aluminum/titanium/zinc/tin compounds, and/or zirconium compounds. Preferred components B are soluble compounds of phosphinic acid of the formula (I) and/or diphosphinic acid of the formula (II), and/or their polymers.

Preferred components A are organic aluminum/titanium/zinc/tin compounds and/or organic zirconium compounds.

Preferred organic aluminum/titanium/zinc/tin compounds and/or organic zirconium compounds are aluminum/titanium/zinc/tin alkoxides and/or zirconium alkoxides.

Preferred aluminum alkoxides are aluminum n-butoxide, aluminum sec-butoxide, aluminum tert-butoxide, and/or aluminum isopropoxide.

Preferred titanium alkoxides are titanium(IV) n-propoxide (®Tilcom NPT, Vertec NPT), titanium(IV) n-butoxide, titanium chloride triisopropoxide, titanium(IV) ethoxide, titanium(IV) 2-ethylhexoxide (®Tilcom EHT, ®Vertec EHT)

Preferred tin alkoxide is stannic tert-butoxide.

Preferred zirconium alkoxide is zirconium(IV) tert-butoxide.

Preference is given here to the use of acetylacetonate as chelating agent.

It is preferable to use an inventive solvent or a mixture of inventive solvents.

The concentration of component A in the inventive solvent is preferably from 0.1 to 50% by weight of metal.

The concentration of component A in the inventive solvent is preferably from 0.1 to 50% by weight of phosphorus.

Preference is also given to the preparation of a nanoparticulate phosphorus-containing flame retardant system via wet grinding.

For this, an inventive non-nanoparticulate phosphorus-containing flame retardant is preferably dispersed at a concentration of from 0.1 to 50% by weight, preferably from 1 to 20% by weight, in an inventive solvent.

Preferred inventive non-nanoparticulate phosphorus-containing flame retardant system has a median particle size (d50) of from 1 μm to 100 μm. The inventive non-nanoparticulate phosphorus-containing flame retardant system preferably has non-spherolitic (-spherical) shape. A rod shape is preferred, the length/thickness quotient being from 1 to 100, particularly preferably from 2 to 10.

It is preferable that from 0.01 to 10% by weight of protective colloids and/or crystallization modifiers, based on nanoparticulate phosphorus-containing flame retardant system, are used during the wet-grinding process.

The inventive nanoparticulate phosphorus-containing flame retardant system preferably comprises from 0.01 to 10% by weight of protective colloids and/or crystallization modifiers.

An example of a preferred assembly is a Sweco M-45 mill, a ZETA™ circulation-mill system from Netzsch, etc.

The expression polymer molding compositions here is synonymous with composites or compounding materials.

Polymers which may be used according to the invention are thermoset and thermoplastic polymers.

The present invention also provides mixtures of the inventive nanoparticulate phosphorus-containing flame retardant system with one or more additives.

Suitable inventive additives are condensates of melamine (e.g. melam, melem and/or melon) or reaction products of melamine with phosphoric acid, or are reaction products of condensates of melamine with phosphoric acid, or else are mixtures of the products mentioned. Examples of condensates of melamine are melem, melam or melon, and compounds of this type with a higher degree of condensation, and also mixtures of the same, and by way of example these can be prepared via the process described in WO 96/16948.

The reaction products with phosphoric acid are compounds which are produced via reaction of melamine or of the condensed melamine compounds, such as melam, melem or melon, etc., with phosphoric acid. Examples of this are melamine polyphosphate, melam polyphosphate, and melem polyphosphate, and mixed polysalts, described by way of example in WO 98/39306. The compounds mentioned have been disclosed previously in the literature and can also be produced by processes other than the direct reaction with phosphoric acid. By way of example, melamine polyphosphate can be prepared by analogy with WO 98/45364 via the reaction of polyphosphoric acid and melamine, or by analogy with WO 98/08898 via the condensation of melamine phosphate or melamine pyrophosphate.

Particularly preferred inventive additives which may be used are melamine phosphate, dimelamine phosphate, melamine pyrophosphate, melamine polyphosphates, melam polyphosphates, melem polyphosphates, and/or melon polyphosphates.

Inventive additives which may be used with preference are oligomeric esters of tris(hydroxyethyl)isocyanurate with aromatic polycarboxylic acids.

Inventive additives which may be used with preference are nitrogen-containing phosphates of the formulae (NH₄)_{y}H_{3-y}PO₄ or (NH₄PO₃)_{z}, where y is from 1 to 3 and z is from 1 to 10 000.

Inventive additives which may be used with preference are nitrogen compounds of the formulae (III) to (VIII), or a mixture thereof

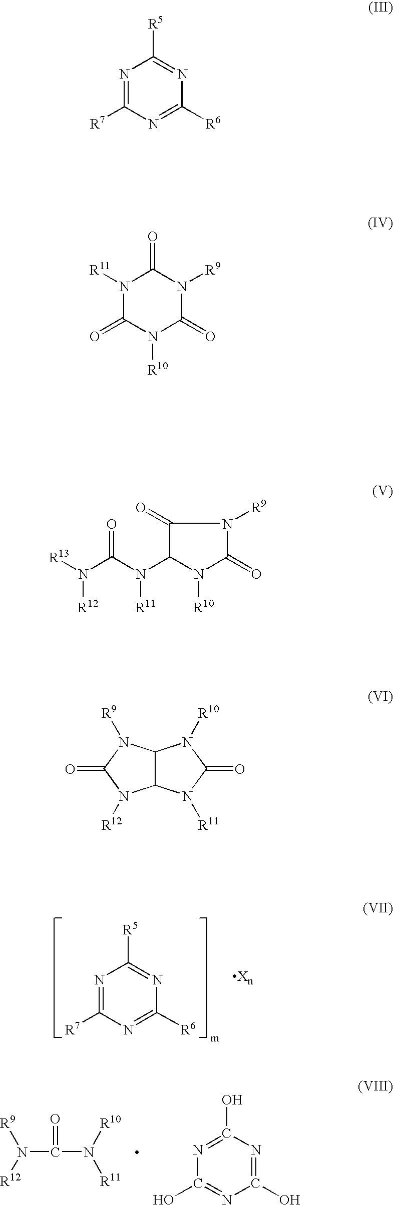

where
R⁵ to R⁷ are hydrogen, C₁-C₈-alkyl, C₅-C₁₆-cycloalkyl or -alkylcycloalkyl, optionally substituted with a hydroxy or a C₁-C₄-hydroxyalkyl function, C₂-C₈-alkenyl, C₁-C₈-alkoxy, -acyl, -acyloxy, C₆-C₁₂-aryl or -arylalkyl, —OR⁸, or —N(R⁸)R⁹, including systems of alicyclic-N or aromatic-N type,
R⁸ is hydrogen, C₁-C₈-alkyl, C₅-C₁₆-cycloalkyl or -alkylcycloalkyl, optionally substituted with a hydroxy or a C₁-C₄-hydroxyalkyl function, C₂-C₈-alkenyl,
C₁-C₈-alkoxy, -acyl, -acyloxy, or C₆-C₁₂-aryl or -arylalkyl,
R⁹ to R¹³ are the same as the groups for R⁸, or else —O—R⁸,
m and n, independently of one another, are 1, 2, 3, or 4,
X is acids which can form adducts with triazine compounds (Ill).

Inventive additives which may be used with preference are benzoguanamine, tris(hydroxyethyl) isocyanurate, allantoin, glycoluril, melamine, melamine cyanurate, dicyandiamide, and/or guanidine.

According to the invention it is also possible to use synergistic combinations of the phosphinates mentioned with the abovementioned nitrogen-containing compounds, these being more effective as flame retardant systems than the phosphinates alone in a wide variety of polymers (DE-A-196 14 424, DE-A-197 34 437, and DE-A-197 37 727). The flame-retardant action of the surface-modified phosphinates can be improved via combination with other flame retardant systems, preferably with nitrogen-containing synergists, or phosphorus/nitrogen flame retardant systems.

Preferred forms of reinforcing materials for flame-retardant polymer molding compositions and flame-retardant polymer moldings are fibers, nonwovens, mats, textiles, strands, tapes, flexible tubes, braids, solid bodies, moldings, and hollow bodies.

Solvents which may be used with preference according to the invention are water, alcohols, such as methanol, ethanol, isopropanol, n-propanol, n-butanol, isobutanol, tert-butanol, n-amyl alcohol, isoamyl alcohol, tert-amyl alcohol, n-hexanol, n-octanol, isooctanol, n-tridecanol, benzyl alcohol, etc. Preference is also given to glycols, e.g. ethylene glycol, 1,2-propanediol, 1,3-propanediol, 1,3-butanediol, 1,4-butanediol, diethylene glycol, etc.; aliphatic hydrocarbons, such as pentane, hexane, heptane, octane, and petroleum ether, naphtha, kerosene, petroleum, paraffin oil, etc.; aromatic hydrocarbons, such as benzene, toluene, xylene, mesitylene, ethylbenzene, diethylbenzene, etc.; halogenated hydrocarbons, such as methylene chloride, chloroform, 1,2-dichloroethane, chlorobenzene, carbon tetrachloride, tetrabromoethylene, etc.; alicyclic hydrocarbons, such as cyclopentane, cyclohexane, and methylcyclohexane, etc.; ethers, such as anisole (methyl phenyl ether), tert-butyl methyl ether, dibenzyl ether, diethyl ether, dioxane, diphenyl ether, methyl vinyl ether, tetrahydrofuran, diisopropyl ether, etc.; glycol ethers, such as diethylene glycol diethyl ether, diethylene glycol dimethyl ether (diglyme), diethylene glycol monobutyl ether, diethylene glycol monomethyl ether, 1,2-dimethoxyethane (DME, monoglyme), ethylene glycol monobutyl ether, triethylene glycol dimethyl ether (triglyme), triethylene glycol monomethyl ether, etc.; ketones, such as acetone, diisobutyl ketone, methyl n-propyl ketone; methyl ethyl ketone, methyl isobutyl ketone, etc.; esters, such as methyl formate, methyl acetate, ethyl acetate, n-propyl acetate, and n-butyl acetate, etc.; carboxylic acids, such as formic acid, acetic acid, propionic acid, butyric acid, etc. One or more of these compounds may be used alone or in combination.

The inventive melt dispersion process converts a non-nanoparticulate phosphorus-containing flame retardant system to a nanoparticulate phosphorus-containing flame retardant system and simultaneously disperses it in the polymer.

The term melt dispersion is synonymous with extrusion, compounding, and/or preparation of a masterbatch.

The conversion of a non-nanoparticulate phosphorus-containing flame retardant system to a nanoparticulate phosphorus-containing flame retardant system during the melt dispersion process can be understood as comminution or milling of crystal agglomerates via shear forces.

In another embodiment, the inventive melt dispersion process disperses, in the polymer, a phosphorus-containing flame retardant system which is nanoparticulate before the process.

The phosphorus-containing flame retardant system can be incorporated into thermoplastic polymers by, for example, premixing all of the constituents in the form of powder and/or pellets in a mixer and then homogenizing the mixture in a compounding assembly (e.g. a twin-screw extruder) in the polymer melt.

The components may also be introduced separately by way of a feed system directly into the compounding assembly.

During the melt dispersion process, the dispersion of the nanoparticulate phosphorus-containing flame retardant system in the matrix polymer is influenced via the addition of compatibilizers, the mixing time, the applied shear, and the polymer viscosity.

The invention also provides a suspension of nanoparticulate phosphorus-containing flame retardant system, prepared by one of the inventive processes with a concentration of from 1 to 50% by weight of nanoparticulate phosphorus-containing flame retardant system.

Determination of Median Particle Size

An Ultra-Turrax mixer is used to disperse 1 g of the solid specimen in a solution of 3% of isopropanol in water. Using a Malvern 4700 C instrument, photocorrelation spectroscopy is used to determine the median particle size.

Determination of the particle size of the nanoparticulate flame retardant system in the plastics matrix

The specimen of the composite is measured in a Philips PWI710 X-ray powder defractometer (CuK_{alpha 2} radiation, wavelength 1.54439 Angstrom, acceleration voltage 35 kV, heating current 28 mA, monochromator, scan rate 3 degrees 2 theta per minute). The median primary particle size D is calculated by the Scherrer method from the line width (beta) of the X-ray reflection at the diffraction angle theta at the position of half-maximum intensity: D=1.54439 [ang]*57.3/(beta*cosine(theta)) (see H. Krischner, Einführung in die Röntgenfeinstrukturanalyse [Introduction to X-ray fine-structure analysis], Vieweg (1987) 106-110).

Preparation, processing and testing of flame-retardant polymer molding compositions and of flame-retardant polymer moldings

The flame retardant system components are mixed with the polymer pellets and optionally with additives, and incorporated in a twin-screw extruder (ZSK 25 WLE, 14.5 kg/h, 200 rpm, L/D: 4) at temperatures of 170° C. (polystyrene), from 230 to 260° C. (PBT), or of 260° C. (PA6), or of from 260 to 280° C. (PA 66). The homogenized polymer strand is drawn off, cooled in a water bath, and then pelletized.

After adequate drying, the molding compositions were processed to give test specimens in an injection-molding machine (Aarburg Allrounder) at melt temperatures of from 240 to 270° C. (PBT), or of 275° C. (PA 6), or of from 260 to 290° C. (PA 66).

Determination of Mechanical Properties on Flame-retardant Polymer Moldings

Tensile strain at break was determined by a method based on DIN EN ISO 527-1.

Impact resistance was determined by a method based on ISO 180.

Determination of Flame Retardancy Properties on Flame-retardant Polymer Moldings

The test specimens are tested and classified for flame retardancy on the basis of the UL 94 test (Underwriters Laboratories).

The UL 94 (Underwriters Laboratories) fire classification was determined on test specimens from each mixture, using test specimens of thickness 1.5 mm.

The UL 94 fire classifications are as follows:

V-0: afterflame time never longer than 10 sec., total of afterflame times for 10 flame applications not more than 50 sec., no flaming drops, no complete consumption of the specimen, afterglow time for specimens never longer than 30 sec. after end of flame application

V-1: afterflame time never longer than 30 sec. after end of flame application, total of afterflame times for 10 flame applications not more than 250 sec., afterglow time for specimens never longer than 60 sec. after end of flame application, other criteria as for V-0

V-2: cotton indicator ignited by flaming drops; other criteria as for V-1 Not classifiable (ncl): does not comply with fire classification V-2.

IEC 60695-1-13 was used for glow-wire ignition test determinations.

Determination of SV Number (Specific Viscosity)

0.5 g of the polymer specimen (e.g. PBT) is weighed into a 250 ml Erlenmeyer flask with ground glass stopper, with 50 ml of dichloroacetic acid (solvent). The specimen is dissolved over a period of 16 h, with stirring at 25°0 C. The solution is filtered through a G1 glass frit. 20 ml of the solution are charged to the capillary, suspended in the (Ubbelohde) capillary viscometer, and controlled to a temperature of 25° C. The SV value is calculated from the following formula: SV value=100*[flow time (specimen solution)/flow time (solvent)−1].

Instead of dichloroacetic acid, a mixture of phenol and 1,2-dichlorobenzene (1:1, w/w) or m-cresol can also be used for polyethylene terephthalate and polybutylene terephthalate. Sulfuric acid, formic acid, or m-cresol can be used for polyamide.

### EXAMPLE 1

99.9 parts by weight of aluminum diethylphosphinate 2 are mixed with 0.1 part by weight of alkylsiloxane (in the form of a 10% strength solution in ethanol) in a Lbdige mixer, and the product is then dried in a drying cabinet at 120° C. for 2 h.

### EXAMPLE 2

99 parts by weight of aluminum diethylphosphinate 2 are mixed with 1 part by weight of alkylsiloxane (in the form of a 10% strength solution in ethanol) in a Lödige mixer, and the product is then dried in a drying cabinet at 120° C. for 2 h.

### EXAMPLE 3

90 parts by weight of aluminum diethylphosphinate 2 are mixed with 10 parts by weight of alkylsiloxane (in the form of a 10% strength solution in ethanol) in a Lödige mixer, and the product is then dried in a drying cabinet at 120° C. for 2 h.

### EXAMPLE 4

A solution of 72 g of sodium diethylphosphinate in 410.6 g of water is heated to 80° C. and then treated with 107 g of aluminum sulfate solution (4.2% by weight of Al) in a microreactor to DE 10 148 615 over a period of 3 h.

The product is washed free from electrolyte via centrifuging and dried at 120° C. for 5 h.

### EXAMPLE 5

A solution of 72 g of sodium diethylphosphinate and 0.65 g of polyethyleneimine in 410.6 g of water is heated to 80° C. and then treated with 107 g of aluminum sulfate solution (4.2% by weight of Al) in a microreactor to DE 10 148 615 over a period of 3 h.

The product is washed free from electrolyte via centrifuging and dried at 120° C. for 5 h.

### EXAMPLE 6

4.54 kg of commercially available aluminum diethylphosphinate 1 (median particle diameter about 22 μm) are ground with 90.72 kg of water in a Sweco M-45 mill for 50 h and then dried. The BET surface area is about 66 m²/g, and the median particle size is 0.023 μm.

### EXAMPLE 7

In accordance with the general specification for “Preparation, processing, and testing of flame-retardant polymer molding compositions and flame-retardant polymer moldings”, 10 parts by weight of aluminum diethylphosphinate 2, 30 parts by weight of glass fibers, and 59.9 parts by weight of nylon-6,6 are processed to give a molding composition. 0.1 part by weight of aminosilane is incorporated as compatibilizer.

### EXAMPLE 8

In accordance with the general specification for “Preparation, processing, and testing of flame-retardant polymer molding compositions and flame-retardant polymer moldings”, 10 parts by weight of aluminum diethylphosphinate 2, 30 parts by weight of glass fibers, and 59 parts by weight of nylon-6,6 are processed to give a molding composition. 1 part by weight of glycidoxysilane is incorporated as compatibilizer.

### EXAMPLE 9

### Comparison

In accordance with the general specification for “Preparation, processing, and testing of flame-retardant polymer molding compositions and flame-retardant polymer moldings”, a molding composition composed of 10% by weight of aluminum diethylphosphinate 1, 5% by weight of melamine polyphosphate, 5% by weight of nanoclay, 3% by weight of glass fibers, and 50% by weight of nylon-6,6 is prepared and processed to give flame-retardant polymer moldings. The test specimens tested to Underwriters Laboratories UL 94 comply with category V-0.

### EXAMPLE 10

In accordance with the general specification for “Preparation, processing, and testing of flame-retardant polymer molding compositions and flame-retardant polymer moldings”, a molding composition composed of 10% by weight of product from Example 2, 30% by weight of glass fibers, and 60% by weight of nylon-6,6 is prepared and processed to give flame-retardant polymer moldings. The test specimens tested to Underwriters Laboratories UL 94 comply with category V-0.

### EXAMPLE 11

In accordance with the general specification for “Preparation, processing, and testing of flame-retardant polymer molding compositions and flame-retardant polymer moldings”, a molding composition composed of 10% by weight of product from Example 3, 30% by weight of glass fibers, and 60% by weight of nylon-6,6 is prepared and processed to give flame-retardant polymer moldings. The test specimens tested to Underwriters Laboratories UL 94 comply with category V-0.

### EXAMPLE 12

In accordance with the general specification for “Preparation, processing, and testing of flame-retardant polymer molding compositions and flame-retardant polymer moldings”, a molding composition composed of 10% by weight of product from Example 4, 30% by weight of glass fibers, and 60% by weight of nylon-6,6 is prepared and processed to give flame-retardant polymer moldings. The test specimens tested to Underwriters Laboratories UL 94 comply with category V-0.

### EXAMPLE 13

In accordance with the general specification for “Preparation, processing, and testing of flame-retardant polymer molding compositions and flame-retardant polymer moldings”, a molding composition composed of 10% by weight of product from Example 5, 30% by weight of glass fibers, and 60% by weight of nylon-6,6 is prepared and processed to give flame-retardant polymer moldings. The test specimens tested to Underwriters Laboratories UL 94 comply with category V-0.

### EXAMPLE 14

In accordance with the general specification for “Preparation, processing, and testing of flame-retardant polymer molding compositions and flame-retardant polymer moldings”, a molding composition composed of 7.5% by weight of product from Example 2, 2.5% by weight of melamine polyphosphate, 30% by weight of glass fibers, and 60% by weight of nylon-6,6 is prepared and processed to give flame-retardant polymer moldings. The test specimens tested to Underwriters Laboratories UL 94 comply with category V-0.

### EXAMPLE 15

In accordance with the general specification for “Preparation, processing, and testing of flame-retardant polymer molding compositions and flame-retardant polymer moldings”, a molding composition composed of 7.5% by weight of product from Example 4, 2.5% by weight of melamine polyphosphate, 30% by weight of glass fibers, and 60% by weight of nylon-6,6 is prepared and processed to give flame-retardant polymer moldings. The test specimens tested to Underwriters Laboratories UL 94 comply with category V-0.

### EXAMPLE 16

In accordance with the general specification for “Preparation, processing, and testing of flame-retardant polymer molding compositions and flame-retardant polymer moldings”, a molding composition composed of 7.5% by weight of product from Example 5 (5), 2.5% by weight of melamine polyphosphate, 30% by weight of glass fibers, and 60% by weight of nylon-6,6 is prepared and processed to give flame-retardant polymer moldings. The test specimens tested to Underwriters Laboratories UL 94 comply with category V-0.

### EXAMPLE 17

In accordance with the general specification for “Preparation, processing, and testing of flame-retardant polymer molding compositions and flame-retardant polymer moldings”, a molding composition composed of 7.5% by weight of product from Example 6 (5a), 2.5% by weight of melamine polyphosphate, 30% by weight of glass fibers, and 60% by weight of nylon-6,6 is prepared and processed to give flame-retardant polymer moldings. The test specimens tested to Underwriters Laboratories UL 94 comply with category V-0.

### EXAMPLE 18

In accordance with the general specification for “Preparation, processing, and testing of flame-retardant polymer molding compositions and flame-retardant polymer moldings”, a molding composition composed of product from Example 7 is prepared and processed to give flame-retardant polymer moldings. The test specimens tested to Underwriters Laboratories UL 94 comply with category V-0.

### EXAMPLE 19

In accordance with the general specification for “Preparation, processing, and testing of flame-retardant polymer molding compositions and flame-retardant polymer moldings”, a molding composition composed of product from Example 8 (5c) is prepared and processed to give flame-retardant polymer moldings. The test specimens tested to Underwriters Laboratories UL 94 comply with category V-0.

### EXAMPLE 20

A solution of 72 g of sodium diethylphosphinate and 0.65 g of Lupasol G20 in 410.6 g of water is heated to 80° C. and then treated with 107 g of aluminum sulfate solution (4.2% by weight of Al) over a period of 3 h.

g of linear sodium dodecylbenzenesulfonate is then added. The reaction solution is heated to about 95° C. over a period of 5 h, during which a mixture of 0.2 g of pinene hydroperoxide (44% of active ingredient) and 51.9 g (0.5 mol) of styrene are metered in by a pump. The product is washed free from electrolyte via centrifuging and dried at 120° C. for 5 h.

### EXAMPLE 21

A solution of 72 g of sodium diethylphosphinate and 0.65 g of gelatin in 410.6 g of water is heated to 80° C. and then treated with 107 g of aluminum sulfate solution (4.2% by weight of Al) over a period of 3 h.

g of linear sodium dodecylbenzenesulfonate is then added. The reaction solution is heated to about 95° C. over a period of 5 h, during which a mixture of 0.2 g of pinene hydroperoxide (44% of active ingredient) and 51.9 g (0.5 mol) of styrene are metered in by a pump. The product is washed free from electrolyte via centrifuging and dried at 120° C. for 5 h.

### EXAMPLE 22

275 g of deionized water are heated to 80° C. and then treated with 41 g of aluminum tri-sec-butoxide over a period of 30 min. This gives a precipitate which can be dissolved over a period of 1 hour by a solution composed of 1.16 g of concentrated nitric acid and 80 g of deionized water.

After stirring for three days, the sol is treated with 61 g of diethylenephosphinic acid. 1.0 g of linear sodium dodecylbenzenesulfonate is then added. The reaction solution is heated to about 95° C. over a period of 5 h, during which a mixture of 0.2 g of pinene hydroperoxide (44% of active ingredient) and 51.9 g (0.5 mol) of styrene are metered in by a pump. The product is washed free from electrolyte via centrifuging and dried at 120° C. for 5 h.

### EXAMPLE 23

A Brabender laboratory kneader is used to prepare a flame-retardant polymer molding composition composed of polystyrene and product from Example 20 (13), and the composition is processed to give flame-retardant polymer moldings. The test specimens tested to Underwriters Laboratories UL 94 comply with category V-0.

### EXAMPLE 24

A Brabender laboratory kneader is used to prepare a flame-retardant polymer molding composition composed of polystyrene and product from Example 21, and the composition is processed to give flame-retardant polymer moldings. The test specimens tested to Underwriters Laboratories UL 94 comply with category V-0.

### EXAMPLE 25

A Brabender laboratory kneader is used to prepare a flame-retardant polymer molding composition composed of polystyrene and product from Example 22 (15), and the composition is processed to give flame-retardant polymer moldings. The test specimens tested to Underwriters Laboratories UL 94 comply with category V-0.

### EXAMPLE 26

A mixture of 40.8 parts by weight of diurethane dimethacrylate derived from 2,2,4-trimethylhexamethylene diisocyanate and 2-hydroxyethyl methacrylate, 24.5 parts by weight of diurethane diacrylate derived from bis(diisocyanatomethyl)tricyclodecane and 2-hydroxyethyl acrylate, 4 parts by weight of dodecanediol dimethacrylate, 12.3 parts by weight of tetraacryloyloxyethoxypentaerythritol, 17.9 parts by weight of product from Example 6 (23 18), and 0.18 part by weight of 3-methacryloylpropyltrimethoxysilane are homogenized using a triple-roll mill.

The transparency of the paste is measured in a photometer (quartz cell d=1 mm, type: ELKO 2, Carl Zeiss, filter No. S51E67). Demineralized water serves as reference solution, and the transparency value measured is read off directly on the equipment.

The transparency is 70%.

### EXAMPLE 27

### Comparison

A mixture of 40.8 parts by weight of diurethane dimethacrylate derived from 2,2,4-trimethylhexamethylene diisocyanate and 2-hydroxyethyl methacrylate, 24.5 parts by weight of diurethane diacrylate derived from bis(diisocyanatomethyl)tricyclodecane and 2-hydroxyethyl acrylate, 4 parts by weight of dodecanediol dimethacrylate, 12.3 parts by weight of tetraacryloyloxyethoxypentaerythritol, 17.9 parts by weight of commercially available aluminum diethylphosphinate 1 (median particle diameter about 22 μm), and 0.18 part by weight of 3-methacryloylpropyltrimethoxysilane are homogenized using a triple-roll mill.

Measurement of transparency gives a value of 40%.

### EXAMPLE 28

part by weight of phenanthrene quinone, 0.2 part by weight of N,N-dimethyl-p-toluidine, 0.02 part by weight of 2,6-di-tert-butyl-4-methylbenzene are mixed with the product from Example 26. The composition is cured for 360 s in open hollow molds composed of metal, using a photopolymerizer (Dentacolor XS from Heraeus Kulzer GmbH) to give a test specimen. The particle size of the nanoparticulate phosphorus-containing flame retardant system in the flame-retardant polymer molding is 0.1 μm, determined in accordance with the general specification. The test specimens tested to Underwriters Laboratories UL 94 comply with category V-0.

TABLE 1

| | | Example | | |
|---|---|---|---|---|
| | | 1 | 2 | 3 |
| Aluminum diethylphosphinate 1 | parts by weight | 99.9 | 99 | 90 |
| Alkylsiloxane | parts by weight | 0.1 | 1 | 10 |

TABLE 2

| | | Example | | | | | | | | | | |
|---|---|---|---|---|---|---|---|---|---|---|---|---|
| | | 9 | 10 | 11 | 12 | 13 | 14 | 15 | 16 | 17 | 18 | 19 |
| Aluminum | % by wt. | 10 | — | — | — | — | — | — | — | — | — | — |
| diethyl phosphinate 1 | | | | | | | | | | | | |
| Melamine | % by wt. | 5 | — | — | — | — | 2.5 | 2.5 | 2.5 | 2.5 | — | — |
| polyphosphate | | | | | | | | | | | | |
| Nanoclay | % by wt. | 5 | — | — | — | — | — | — | — | — | — | — |
| Product from | % by wt. | — | 10 | — | — | — | 7.5 | — | — | — | — | — |
| Example 2 | | | | | | | | | | | | |
| Product from | % by wt. | — | — | 10 | — | — | — | — | — | — | — | — |
| Example 3 | | | | | | | | | | | | |
| Product from | % by wt. | — | — | — | 10 | — | — | 7.5 | — | — | — | — |
| Example 4 | | | | | | | | | | | | |
| Product from | % by wt. | — | — | — | — | 10 | — | — | 7.5 | — | — | — |
| Example 5 | | | | | | | | | | | | |
| Product from | % by wt. | — | — | — | — | — | — | — | — | 7.5 | — | — |
| Example 6 | | | | | | | | | | | | |
| Product from | % by wt. | — | — | — | — | — | — | — | — | — | x | — |
| Example 7 | | | | | | | | | | | | |
| Product from | % by wt. | — | — | — | — | — | — | — | — | — | — | x |
| Example 8 | | | | | | | | | | | | |
| Glass fibers | % by wt. | 30 | 30 | 30 | 30 | 30 | 30 | 30 | 30 | 30 | 30 | 30 |
| Nylon-6,6 | % by wt. | 50 | 60 | 60 | 60 | 60 | 60 | 60 | 60 | 60 | 70 | 70 |
| Median particle | μm | 40.00 | 0.50 | 0.10 | 0.20 | 0.20 | 0.25 | 0.15 | 0.20 | 0.05 | 0.40 | 0.30 |
| diameter d50 | | | | | | | | | | | | |
| GWIT to IEC | ° C. | 800 | 800 | 800 | 825 | 850 | 800 | 850 | 850 | 850 | 825 | 825 |
| 60695-1-13 | | | | | | | | | | | | |
| Tensile strain | % | 1.6 | 1.9 | 2.1 | 2 | 2.2 | 2.2 | 2 | 2.2 | 2 | 1.9 | 2.2 |
| at break to | | | | | | | | | | | | |
| DIN 53455 | | | | | | | | | | | | |
| Charpy impact | kJ/m2 | 40 | 55 | 60 | 62 | 55 | 55 | 57 | 60 | 57 | 55 | 62 |
| resistance to | | | | | | | | | | | | |
| ISO 180 | | | | | | | | | | | | |

TABLE 3

| | | Example | | |
|---|---|---|---|---|
| | | 23 | 24 | 25 |
| Product from Example 20 | % by wt. | 54.0 | — | — |
| Product from Example 21 | % by wt. | — | 54.0 | — |
| Product from Example 22 | % by wt. | — | — | 54.0 |
| Polystyrene | % by wt. | 46.0 | 46.0 | 46.0 |
| Median particle diameter d50 | μm | 0.25 | 0.15 | 0.15 |
| P content | % by wt. | 7.2 | 7.2 | 7.2 |

TABLE 4

| | |
|---|---|
| Aluminum diethylphosphinate 1 | Exolit OP 1230, Clariant Corporation |
| Aluminum diethylphosphinate 2 | Exolit O 930 (TP), Clariant |
| | Corporation |
| Alkylsiloxane | Dynasylan BSM 166, Degussa |
| Aminosilane | gamma-aminopropyltriethoxysilane, |
| | Silquest A-1100 silane, Crompton |
| Glycidoxysilane | 3-Glycidoxypropyltrimethoxsilane, |
| | Z 6040 silane, Dow Corning |
| Nanoclay | Nanofill 919, Südchemie |
| Nylon-6,6 | Ultramid A3, BASF |
| Glass fibers | PPG 3540, PPG Industries, Inc. |
| Polystyrene | Polystyrene 143 E, BASF |
| Melamine polyphosphate | Melapur 200/70, Ciba SC |
| Polyethyleneimine | Lupasol G20, BASF |

1. A nanoparticulate phosphorus-containing flame retardant system, comprising a phosphinic salt of the formula (I) a diphosphinic salt of the formula (II) a polymer of the phosphinic salt, a polymer of the diphosphinic salt, or a mixture thereof, 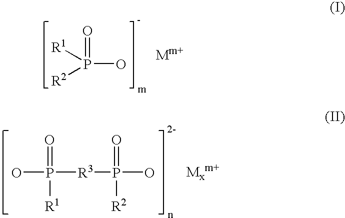
wherein
R¹ and R² are identical or different and are C₁-C₆-alkyl, linear or branched, and/or or aryl;
R³ is C₁-C₁₀-alkylene, linear or branched, C₆-C₁₀-arylene, -alkylarylene, or -arylalkylene;
M is Mg, Ca, Al, Sb, Sn, Ge, Ti, Fe, Zr, Zn, Ce, Bi, Sr, Mn, Li, Na, K, or a protonated nitrogen base;
m is from 1 to 4;
n is from 1 to 4;
x is from 1 to 4.

2. The nanoparticulate phosphorus-containing flame retardant system as claimed in claim 1, wherein R¹ and R² are identical or different and are C₁-C₆-alkyl, linear or branched, or phenyl.

3. The nanoparticulate phosphorus-containing flame retardant system as claimed in claim 1, wherein R¹ and R² are identical or different and are methyl, ethyl, n-propyl, isopropyl, n-butyl, tert-butyl, n-pentyl or phenyl.

4. The nanoparticulate phosphorus-containing flame retardant system as claimed in claim 1, wherein R³ is methylene, ethylene, n-propylene, isopropylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, tert-butyinaphthylene, phenylmethylene, phenylethylene, phenylpropylene, or phenylbutylene.

5. The nanoparticulate phosphorus-containing flame retardant system as claimed in claim 1, having a particle size sfrom 1 to 1000 nm.

6. The nanoparticulate phosphorus-containing flame retardant system as claimed in claim 1, wherein the BET surface area is from 2 to 1000 m²/g.

7. The nanoparticulate phosphorus-containing flame retardant system as claimed in claim 1, further comprising from 0.01 to 10% by weight of at least one of a protective colloids or a crystallization modifier.

8. A process for the preparation of a nanoparticulate phosphorus-containing flame retardant system as claimed in claim 1, comprising the step of reacting
A) an aluminum/zinc/titanium/zirconium compound, a tin compound or a mixture thereof with
B) a soluble compound of phosphinic acid of the formula (I) a diphosphinic acid of the formula (II) a polymer of the phosphinic acid. a polymer of the diphosphinic acid or a mixture thereof, and, optionally,
C) from 0.01 to 10% by weight of at least one of a protective colloid and a crystallization modifier,
to form the flame retardant system and optionally, isolating the flame retardant system, drying the flame retardant system, and grinding the flame retardant system.

9. A process for the preparation of a nanoparticulate phosphorus-containing flame retardant system as claimed in claim 1, comprising the steps of
A) hydrolyzing an aluminum/titanium/zinc/tin compound, a zirconium compound, and
B) reacting the product with a soluble compound of phosphinic acid of the formula (I) the diphosphinic acid of the formula (II) a polymer of the phosphinic acid. a polymer of the diphosphinic acid or a mixture thereof, or performing the hydrolyzing step in the presence of a soluble compound of phosihinic acid of the formula (I) the diphosphinic acid of the formula (II) a polymer of the phosphinic acid, a Polymer of the diphosphinic acid or a mixture thereof to form the flame retardant system, and, optionally, isolating the flame retardant system, drying the flame retardant system, and grinding the flame retardant system.

10. The process as claimed in claim 8, wherein the reaction is conducted in at least one of a microreactor or minireactor.

11. The process as claimed in claim 8, wherein the metal charge equivalentimol of phosphorus ratio A:B in which components A) and B) are used is from 100:1 to 1:100.

12. The process as claimed in claim 8, wherein the temperature is from 0 to 300° C., the reaction time is from 1*10⁻⁷ to 1*10² h, and the pressure is from 1 to 200 MPa.

13. The process as claimed in claim 10, wherein the throughput in the microreactor is from 10⁻³ l/h to 10³ l/h, and in the minireactor is from 10² l/h to 10⁵ l/h.

14. A process for the preparation of a nanoparticulate phosphorus-containing flame retardant system as claimed in claim 1, comprising the steps of wet-grinding a non-nanoparticulate phosphorus-containing flame retardant system to a particle size to from 1 to 1000 nm, and, optionally, adding from 0.01 to 10% by weight of at least one of a protective colloid or crystallization modifier to form a nanoparticulate phosphorus-containing flame retardant system, and optionally, isolating the nanoparticulate phosphorus-containing flame retardant system drying the nanoparticulate phosphorus-containing flame retardant system, and grinding the nanoparticulate phosphorus-containing flame retardant system.

15. The process as claimed in claim 14, wherein the non-nanoparticulate phosphorus-containing flame retardant system is dispersed at a concentration of from 0.1 to 50% by weight in a solvent, wherein the temperature is from 0 to 300° C., the reaction time is from 1*10⁻⁷ to 1*10² h, and the pressure is from 1 to 200 MPa.

16. The process as claimed in claim 8, wherein the reacting step takes place in the presence of a solvent and the isolation of the nanoparticulate phosphorus-containing flame retardant system from the solvent takes place via filtration, sedimentation, or centrifuging.

17. The process as claimed in claim 8, wherein the reacting step produces ancillary components and wherein the isolation of the nanoparticulate phosphorus-containing flame retardant system from the ancillary components takes place via treatment with a solvent in a ratio of from 1:100 to 100:1 parts by weight, and isolation of the nanoparticulate phosphorus-containing flame retardant system from the solvent via filtration, sedimentation, or centrifuging.

18. The process as claimed in claim 8, wherein the drying step takes place in one or more stages at a pressure of from 10 Pa to 100 MPa, for a period of from 0.01 to 1000 h, and at a temperature of from −20 to +500° C.

19. The process as claimed in claim 8, wherein the grinding step occurs in at least one of a hammer mill, impact mill, vibratory mill, roll mill, floating-roller mill or air-jet mill.

20. The process as claimed in claim 8, wherein component B is dispersed in a solvent and the concentration of component B in the solvent is from 0.1 to 50% by weight of phosphorus.

21. The process as claimed in one or more of claims 8 to 20, wherein the aluminum/titanium/zinc/tin compound, zirconium compound or mixture thereof is an organic compound.

22. A polymer article comprising a nanoparticulate phosphorus-containing flame retardant system as claimed in claim 1, wherein the polymer article is a polymer molding composition, polymer molding, polymer filament, polymer film or polymer fiber.

23. A flame retardant composition comprising a nanoparticulate phosphorus-containing flame retardant system as claimed in claim 1, wherein the flame retardant composition is a flame-retardant coating, gel coat, intumescent lacquer, clear lacquer, topcoat, adhesive or adhesion coating.

24. The nanoparticulate phosphorus-containing flame retardant system as claimed in claim 1, having a particle size from 5 to 500 nm.

25. The nanoparticulate phosphorus-containing flame retardant system as claimed in claim 1, wherein the BET surface area is from 5 to 500 m²/g.

26. The process as claimed in claim 8, wherein the metal charge equivalent/mol of phosphorus ratio A:B in which components A) and B) are used is from 10:1 to 1:10.

27. The process as claimed in claim 14, wherein the particle size is from 1 to 1000 nm.

28. The process as claimed in claim 15, wherein the non-nanoparticulate phosphorus-containing flame retardant system is dispersed at a concentration of from 1 to 20% by weight.

29. The process as claimed in claim 18, wherein the temperature is from 50 to 350° C.

30. The process as claimed in claim 20, wherein the concentration of component B in the solvent is from 1 to 30% by weight of phosphorus.

31. A porous article impregnated with a nanoparticulate phosphorus-containing flame retardant system as claimed in claim 1, wherein the porous article is wood, particle board, cork, paper or textile.
